(19) United States
(12) Patent Application Publication
(10) Pub. No.: US 2013/0117197 A1
(43) Pub. Date: May 9, 2013

(54) Determination of a Size of a Credit Default Swap Guaranty Fund

(71) Applicants: Pavan Shah, Chicago, IL (US); Ketan Patel, Hanover Park, IL (US); Ziyi Wang, Chicago, IL (US); Ankeet Dedhia, Chicago, IL (US)

(72) Inventors: Pavan Shah, Chicago, IL (US); Ketan Patel, Hanover Park, IL (US); Ziyi Wang, Chicago, IL (US); Ankeet Dedhia, Chicago, IL (US)

(73) Assignee: Chicago Mercantile Exchange Inc., Chicago, IL (US)

(21) Appl. No.: 13/323,436

(22) Filed: Dec. 12, 2011

Related U.S. Application Data
(60) Provisional application No. 61/556,930, filed on Nov. 8, 2011.

(51) Int. Cl. G06Q 40/06

(52) U.S. Cl. 705/36 R

(57) ABSTRACT

A system for determining an amount of a guaranty fund to cover mutual systemic risk of loss among a plurality of entities trading credit default swap (“CDS”) instruments using a central counterparty, such as the CME, is disclosed. The disclosed embodiments relate to a system and method for calculating a value, i.e. the size or magnitude, such as in dollars, of a CDS guaranty fund, such as more optimal size thereof, e.g. a size more reflective of the true risk, or each member's contribution thereto, thereby reducing or minimizing the burden on participants while adequately ensuring that risks are covered. The disclosed embodiments utilize a generalized approach to avoid too many risk scenarios while still accounting for all relevant possible portfolio constructions.

### REFERENCE TO RELATED APPLICATIONS

This application claims the benefit of the filing date under 35 U.S.C. §119(e) of U.S. Provisional Application Ser. No. 61/556,930 filed Nov. 8, 2011, which is hereby incorporated by reference.

### BACKGROUND

A credit default swap (“CDS”) is a contract between two parties, the protection buyer and a protection seller, whereby the protection buyer is compensated for the loss generated by a credit event in a reference instrument. The credit event can be the default of the reference entity, lack of payment of a coupon or other corporate events defined in the contract. In return the protection buyer pays a premium, e.g. equal to an annual percentage X of the notional or face value/amount, to the protection seller. The premium X, quoted in basis points or percentage points of the notional, i.e. face, amount, is called the CDS spread. CDS's are often analyzed by graphing the CDS spread vs. maturity which results in a curve. This spread is paid, for example, (semi)annually or quarterly in arrears until either maturity is reached or default occurs. In the case of default occurring prior to maturity, the protection seller pays the protection buyer the face value of the reference asset minus its post-default market value, through physical or cash settlement. Thus, the protection buyer is protected against losses in case the reference entity defaults. If the buyer owns the reference security, the CDS acts as a hedge against default: such ‘insurance against default’ was the initial motivation for introducing credit default swaps.

However, unlike insurance contracts, credit default swaps do not require exposure to the underlying credit risk: a CDS may be used to gain a synthetic exposure to the credit risk of a firm. Compared to the strategy of holding (or shorting) the corresponding bond, the CDS strategy leads to the same exposure but only requires a small amount of capital at inception, equal to the collateral or margin posted with the counterparty. Also, in instances where the underlying bond may be difficult to short, the CDS enables to take a speculative short position that benefits from a deterioration of the issuer's creditworthiness. The sheer volume of the CDS market indicates that a substantial portion of contracts are speculative; in principle, the outstanding notional of credit default swaps may even become larger than the total debt of the reference entity.

Credit default swaps are over-the-counter (“OTC”) derivatives: they are not exchange-traded. The CDS market is a dealer market where a few major institutions control an overwhelming proportion of the volume and post quotes for protection premiums on various reference entities.

Central counterparties (“CCPs”) have been proposed as a solution for mitigating counterparty risk and preventing default contagion in the CDS market. A clearinghouse (or central counterparty) acts as the buyer to every seller and seller to every buyer of protection, thereby isolating each participant from the default of other participants. Participants post collateral with the central counterparty and are subject to daily margin calls. This helps reduce losses in case of default and mitigates counterparty risk. Also, management of collateral and margin calls by the CCP can help reduce operational risk in the CDS market.

A clearinghouse is not an exchange: prices are still negotiated over the counter and there is no auction mechanism for price fixing. However, for the purpose of marking positions and computing margins, clearinghouse participants are required to post quotes for all instruments being cleared, which leads to some degree of price transparency.

### BRIEF DESCRIPTION OF THE DRAWINGS

FIG. 1 depicts a flow chart depicting one part of the exemplary operation of the system of FIG. 13.

FIG. 2 depicts a worksheet showing exemplary results of the operation of the system of FIG. 13.

FIGS. 3 and 4 depict exemplary application of the disclosed embodiments to exemplary portfolios.

FIG. 5 depicts a comparison of portfolios.

FIG. 6 depicts a block diagram of the systematic stress test according to one embodiment.

FIG. 7 depicts a block diagram of the curve stress test according to one embodiment.

FIG. 8 depicts a block diagram of the sector stress test according to one embodiment.

FIG. 9 depicts a block diagram of the convergence/divergence stress test according to one embodiment.

FIG. 10 depicts a block diagram of the idiosyncratic stress test according to one embodiment.

FIG. 11 depicts a block diagram of the basis stress test according to one embodiment.

FIG. 12 shows a table of exemplary shock values for use with the disclosed embodiments.

FIG. 13 depicts a block diagram of an exemplary system for sizing a guaranty fund according to one embodiment.

FIG. 14 depicts a flow chart showing exemplary operation of the system of FIG. 13.

FIG. 15 depicts an illustrative embodiment of a computer system for use with the system of FIG. 13.

### DETAILED DESCRIPTION OF THE DRAWINGS AND PRESENTLY PREFERRED EMBODIMENTS

Given their important role as a bulwark against counterparty risk and contagion, Central Counterparties (“CCPs”) need to use stringent risk management procedures to ensure their own stability, including in stress scenarios when a large dealer may default. Risk management of central counterparties is currently done at several levels:
Screening and monitoring of the credit risks of clearing members through membership requirements, notably based on minimum capital requirements on members.
Margin requirements are used to absorb short term losses and first losses in case of the default of a clearing member. The horizon over which losses are considered is related to the anticipated time frame necessary for unwinding a position in the market under consideration. For CDS markets this corresponds to a few days. Margin levels are adjusted daily through margin calls.
Guaranty fund or clearing fund: large losses not covered by the margin are covered by a guaranty fund, to which clearing members contribute according to the risk of their position. By mutualizing extreme risks, the guaranty fund contributes to the overall stability of the clearinghouse and reduces systemic risk by immunizing each member from the default of others.

Margin requirements should be designed to cover short term losses, which may arise from CDS spread volatility or from losses due to the default of the underlying reference entity of the CDS (referred to as “jump-to-default” or “JTD”). CDS spreads are observed to be highly volatile and exhibit large fluctuations and margin levels should account for this “heavy-tailed” nature of the risk. It is generally desirable for margin requirements to be very responsive to short term, e.g. over 5 days or less, market fluctuations.

Computing appropriate jump-to-default requirements for clearing members should be based on loss given default, not on expected loss as is often done in current OTC margin agreements. For a stand-alone ‘naked’ single name CDS, this would lead to a large collateral requirement, which would strongly discourage the protection seller. For a CDS portfolio, however, it may be feasible to require that the margin covers the loss given a fixed number of defaults in the portfolio over the risk horizon (usually a few days).

Whereas margin concerns the short term risk of each clearing members portfolio, the guaranty fund addresses systemic risk or “tail” risk faced by the CCP. Tail risk is the possibility of an investment's value moving more than three standard deviations from the mean being greater than what may be shown in a normal distribution and generally refers to portfolios with distributions of returns that do not follow a normal or expected pattern. Guaranty fund requirements are generally not viewed as an additional margin: the guaranty fund's main role should be to mutualize extreme losses in excess of margin. Such extreme losses typically occur in the event of the default of a clearing member and arise from the cost of liquidating its position. The level of the guaranty fund may be fixed in order to cover liquidation costs in extreme but plausible scenarios. Currently it is recommended to require a CCP to dispose of sufficient funds to cover losses due to default of any single clearing member, but regulators have considered, in practice, two or more dealer defaults in some cases.

Central counterparties may stress test their risk management system in order to assess the adequacy of the level of margin and guaranty fund requirements. The outcome of the stress test largely depends on the configuration of portfolios of clearing members: a market where most clearing members/dealers have are large net protection buyers or sellers represents a different risk than a market where most clearing members have well-balanced long-short portfolios. Therefore a meaningful stress test needs to consider different portfolio configurations for clearing members and identify (plausible) worst case scenarios from the viewpoint of the central counterparty's risk. For example, one could simulate plausible portfolio configurations for clearing members and consider, across the simulated scenarios, the cost of liquidating each dealers portfolios in case of their default. This cost, net of margin, determines the risk posed by the dealer to the CCP and its allocation to the guaranty fund should be determined accordingly.

While the disclosed embodiments will be described in reference to the Chicago Mercantile Exchange (“CME” or “CME Group”), it will be appreciated that these embodiments are applicable to any Exchange, including those which trade in equities and other securities. The CME Clearing House clears, settles and guarantees all matched transactions in CME contracts occurring through its facilities. In addition, the CME Clearing House establishes and monitors financial requirements for clearing members and conveys certain clearing privileges in conjunction with the relevant exchange markets.

As the central counterparty to each of the Participants, CME may have exposure to the risk of their default. To address this counterparty credit risk, CME may require Participants to provide collateral for their obligations under cleared CDS transactions, and may have rules that mutualize the risk of a Participant default across all Participants. Each Participant, therefore, may be required to both post margin and make contributions to a guaranty fund. Each Participant may be required to make an initial, uniform contribution to the guaranty fund, as well as contributions made on an ongoing basis based on the Participant's actual and anticipated CDS position exposures. CME may also contribute to the guaranty fund. As a result, the guaranty fund may grow in proportion to the position risk associated with the aggregate volume of CDS cleared by CME.

If a Participant defaults, CME may draw on the margin collateral the Participant has posted. If that is insufficient, CME may then look to the defaulting Participant's guaranty fund contribution. CME may use other guaranty fund contributions to satisfy any remaining obligations of the defaulting Participant. If the total guaranty fund is inadequate to cover losses on the defaulted obligations, CME may have the ability to assess an additional guaranty fund contribution from all non-defaulting Participants, subject to certain limitations in CME's rules.

As described above, guaranty funds, along with margin accounts, are part of the general CDS financial safeguards package. Guaranty funds act with margin accounts as an additional layer of protection to account for extreme market circumstances. The guaranty fund is contributed to by specific clearing members, and the fund is shared by all clearing members in a pool. The CDS guaranty fund accounts for extreme instances of risk that are not accounted for by the CDS margin model, e.g. systemic risks and/or risks to the CCP itself.

The disclosed embodiments relate to a method for calculating a value, i.e. the size or magnitude, such as in dollars, of a CDS guaranty fund, such as more optimal size thereof, e.g. a size more reflective of the true risk, or each member's contribution thereto, thereby reducing or minimizing the burden on participants while adequately ensuring that risks are covered. The disclosed embodiments utilize a generalized approach to avoid too many risk scenarios while still accounting for all relevant possible portfolio constructions.

Other methods of calculating the guaranty fund may rely on the CDS margin model which is used to calculate the margin necessary to cover short term losses and/or risks limited to a individual participant. In applying the CDS margin model to sizing the guaranty fund, extreme scenarios may be used to calculate maximum loss and/or the model analysis may be applied over a longer period of time, e.g. greater than 5 days. However, such use of the margin model may drastically overestimates the size of the guaranty fund due to double-counting certain risks, i.e. those risks having a significant amount of multi-collinearity, that is, a high degree of dependence or correlation, and, therefore, may result in being too punitive on the participants. In other words, using a method which is based on non-unique sources of risk and does not factor out correlated risks may result in double and triple counting.

The disclosed embodiments eliminate double (or more)-counting of correlated risks in each clearing member's portfolio by removing certain reference entities, i.e. debtor entities and the CDS positions which they underlie, identified during initial stress test factor calculations from subsequent stress test factor calculations, as will be described in more detail below. For example, the two reference entities that are identified as having the largest magnitude jump-to-default (JTD) or jump-to-health (JTH) risk values that will be summed to derive the idiosyncratic contribution to the overall stress test, reflecting that, dependent upon the position held by the clearing member in the CDS instrument based thereon, e.g. long or short, either a JTD or JTH may cause a loss therein, will be removed from the sector stress computation as the sector stress test would again factor in this same risk overshadowing sector risk incurred by the other entities and skewing the results. Secondly, the two entities having largest Sector losses may also be removed from the systematic stress test calculation. Similar to the idiosyncratic vs. sector stress tests, removing these entities having large sector losses from the systematic stress test computations avoids skewing results of the systematic stress test unnecessarily, because the systematic stress test is based on CDS indices whose constituent instruments are spread across a variety of sectors.

In one embodiment, the size of the guaranty fund may be based on a portfolio by portfolio analysis comprising, for each, a summation of the maximum four out of six stress tests on various risk factors, plus the worst-case liquidity stress test value. In particular, the CDS Guaranty Fund (“GF”) may be sized by the two largest net debtor clearing members. That is, the size of the GF may be determined by looking at the two largest shortfalls, i.e. for each clearing member, computing the difference between the largest loss under various stress scenarios, referred to as “GF Stress,” and the margin the clearing member is required to post by the applicable CDS margin model to cover short term losses where the size of the GF may be the sum of the two largest of these shortfalls among all of the clearing members. The GF Stress value for each clearing member may determined by applying stress tests on the respective clearing member's portfolio as follows:

GF Stress=Worst Case Liquidity+MAX four stress test(Systematic,Sector,Curve,Convergence/Divergence;Idiosyncratic;Basis)

In one embodiment, the stress tests are separately applied to each portfolio and include Systematic, Sector, Curve, Convergence/Divergence, Idiosyncratic and Basis stress tests. For each portfolio, the results, or subset thereof, are then summed, subject to rules as will be described below, to compute an overall result for each test. In particular, these six stress tests/factors address both market risks and firm-specific risks and may also be used in CDS margin method as well. They represent an industry consensus on an exhaustive list of risk for the CDS instrument and, therefore, utilizing each of them may substantially capture any and all risk that any CDS portfolio is likely to be exposed to, with the goal of being able to capture risk in any CDS portfolio. It will be appreciated that other stress tests may be used which account for the various risks that a CDS instrument may involve. It will be appreciated, however, that, a comprehensive set of tests/factors should be used to ensure that the potential risks are captured and accounted for, such that the fund is not undersized. In implementations where certain risks may be avoided or other risks are introduced, it will be further appreciated that a test/factor accounting for that risk may or may not be needed. Therefore, in one embodiment, all six of the tests/factors may be required. As different portfolios may be subject to different risks, for a given portfolio, any one of the six factors may be significant. Depending on the portfolio characteristics, i.e. is it a directional portfolio, hedged, etc., various factors above will capture risks embedded in the portfolio. Therefore, each factor may be viewed to be equally important in this stress testing method.

The goal of each test is as follows:
1) Systematic: capture parallel movements in CDS yield curve(s), i.e. yield vs. maturity, indicative of an event, market or otherwise, which effects the entire CDS market;
2) Curve: capture non-parallel movements, i.e. twists, in CDS yield curve(s), indicative of events, market or otherwise, which effect only CDS's of particular maturities, such as the “short end”, i.e. those CDS's with a maturity of 2 years or less;
3) Sector: capture the risk that one of few CDS underlying entities in a sector could make the entire sector risky. This stress test aims to model concentration risk;
4) Convergence/Divergence: capture the risk of CDS's having low, i.e. categorized by the industry as investment grade (“IG”), spreads or having high, i.e. categorized by the industry as high yield (“HY”), spreads, explained in more detail below, moving away from expected values in a regression analysis. This factor aims to capture risk embedded in portfolios that contain IG and HY positions, i.e. long HY short IG, or vice-versa;
5) Idiosyncratic: captures the risk of CDS underlying entities jumping to default or brought back to health instantaneously. This represents firm specific risk; and
6) Basis: captures the risk of mispricing an index relative to its constituents. This factor aims to capture risks in total and partial arbitrage portfolios, i.e. long/buy the index and short/sell all or some constituents.

Stress testing is a form of testing that is used to determine the stability of a given system or entity. It involves testing beyond normal operational capacity, often to a breaking point, in order to observe the results. In the financial sector, instead of doing financial projection on a “best estimate” basis, a company may do stress testing where they look at how robust a financial instrument is in certain crashes, a form of scenario analysis. They may test the instrument under, for example, the following stresses:
What happens if equity markets crash by more than x % this year?
What happens if interest rates go up by at least y %?
What if half the instruments in the portfolio terminate their contracts in the fifth year?
What happens if oil prices rise by 200%?

Stress testing, for example, reveals how well a portfolio is positioned in the event forecasts prove true. Stress testing also lends insight into a portfolio's vulnerabilities. Though extreme events are never certain, studying their performance implications strengthens understanding.

Stress testing defines a scenario and uses a specific algorithm to determine the expected impact on a portfolio's return should such a scenario occur. For example, there may the following types of scenarios:
1. Extreme event: hypothesize the portfolio's return given the recurrence of a historical event. Current positions and risk exposures are combined with the historical factor returns.
2. Risk factor shock: shock any factor in the chosen risk model by a user-specified amount. The factor exposures remain unchanged, while the covariance matrix is used to adjust the factor returns based on their correlation with the shocked factor.
3. External factor shock: instead of a risk factor, shock any index, macro-economic series (e.g., oil prices), or custom series (e.g., exchange rates). Using regression analysis, new factor returns are estimated as a result of the shock.

In an exponentially weighted stress test, for example, historical periods more like the defined scenario receive a more significant weighting in the predicted outcome. The defined decay rate lets the tester manipulate the relative importance of the most similar periods. In the standard stress test, each period is equally weighted.

In one embodiment, each position of a clearing member's portfolio is subjected to “up” and “down” shocks for each stress test factor; the maximum loss resulting from these shocks is then used as the contribution to the overall stress test for the portfolio. The liquidity factor stress test may always be included in the guaranty fund calculation because an entity stands to suffer substantial losses in the event that the market becomes illiquid. As describe above, the GF stress test on the portfolio will be determined by adding the maximum four out of six stress tests on various risk factors. The worst-case liquidity stress test may always be added to the total. A liquidity stress test, for example, may be a function of bid-offer spread of a CDS contract, gross notional/net notional and volume over a multi-day, e.g. 10, horizon. Furthermore, the liquidity stress test may adjust for the size of the portfolio, i.e. the larger the portfolio in terms of notional, the higher the liquidation cost. This factor differs from all others since it doesn't depend on profit and loss (“P&L”), i.e. there is no re-pricing and the CDS spreads are not shocked as is done for the other stress tests. The goal of this factor is to quantify the change in the value of portfolio due to change in supply and demand in the market. This factor is required to model growing liquidation cost for instruments that are hardly traded.

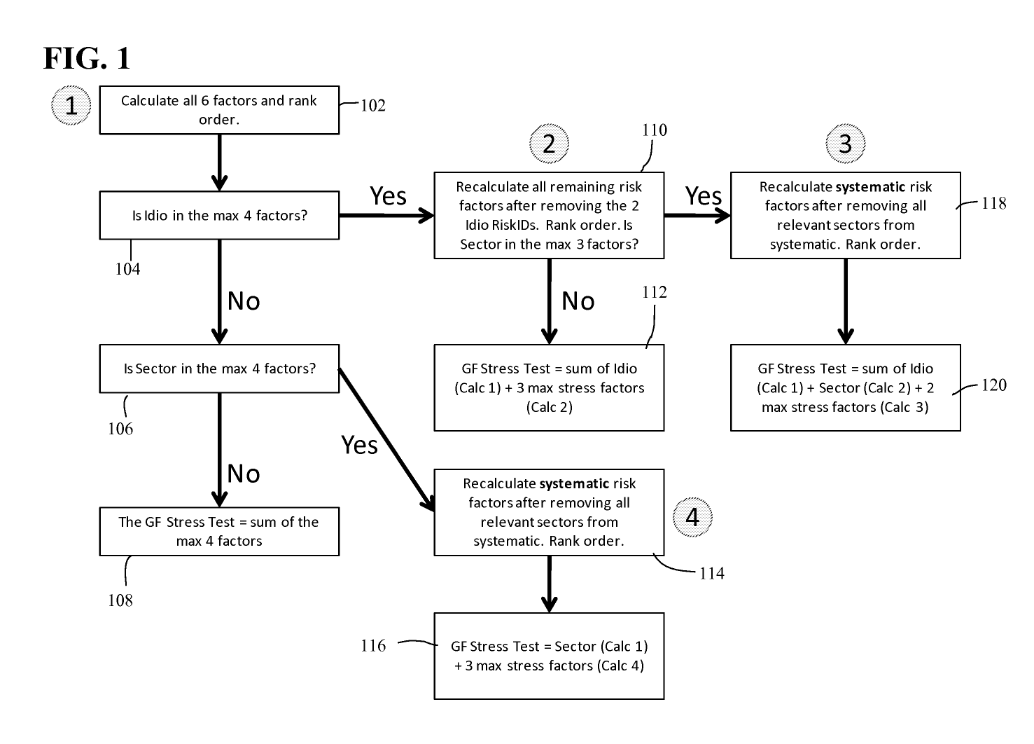

After the six stress test factors are calculated, they are ordered by dollar magnitude. Correlated risks are addressed by adding the four factors having the largest magnitude. To avoid double-counting correlated risks between the remaining stress test factors, certain conditions, shown in FIG. 1 and discussed in more detail below, which may vary portfolio to portfolio, will lead to the removal of reference entities presenting the highest risk of default, referred to herein as the “defaulting” or “defaulted” entities, from the calculation of subsequent stress test factors. For example, if the Sector factor is calculated to be among the top four factors, two defaulting reference entities in that sector will be removed for the subsequent Systematic factor calculation as they would represent correlated risk. Entities may be removed to ensure that subsequent stress tests do not include them so as to avoid correlated sources of risk which would result in the size of GF being larger than it needs to be. FIG. 1 shows a flowchart which depicts the procedure for removing idiosyncratic factor (jump-to-default (“JTD”) and jump-to-health (“JTH”)) and Sector risks from being included in other risk factors, which, as has been described, may be done to ensure there is no double-counting, e.g. once sector risk is addressed, it should not be counted again in other stress tests to avoid the results of the other stress tests being unnecessarily skewed.

Several rules (which are integrated into the process) may be used to address correlated risks and double counting:
1. Sector stress will be the sum of the maximum two sector losses from the twenty stress tests (ten sectors, up/down) in order to remove correlated sector risks later in the process;
2. If Sector is one of the max four stress tests, an adjusted systematic factor will be used that removes the relevant sectors from the systematic stress test to ensure no double-counting;
3. If Idiosyncratic (JTD/JTH) is one of the max four stress tests, the relevant reference entities will be removed from all stress tests. JTD and JTH represent the risk that an entity will default while JTH represents the risk that an entity will become healthy, such as by being bailed out. Defaulted/Healthy entities are removed from subsequent stress tests to ensure that their effect will not be included again;
4. Sector shocks will be relative to the sector (i.e. Financials will have a Financials specific up/down shock, Utilities will have a Utilities up/down shock, etc.) Each sector needs to have its own shock as opposed to having one shock for all sectors as each sector represents different risk based on their historical movements. Some sectors are, and have been, more volatile than others. For example, Oil and Gas and Financials sectors have been more volatile than Utilities. Therefore, it may be incorrect to treat them the same by applying a “Financials” shocks to instruments in portfolio belonging to utilities sector; and
5. Sector shocks will have a minimum value equal to the systematic shock. In order to capture the tail risk, i.e. protect against catastrophic defaults, a “floor” is needed. Systematic shock represents the overall market risk.

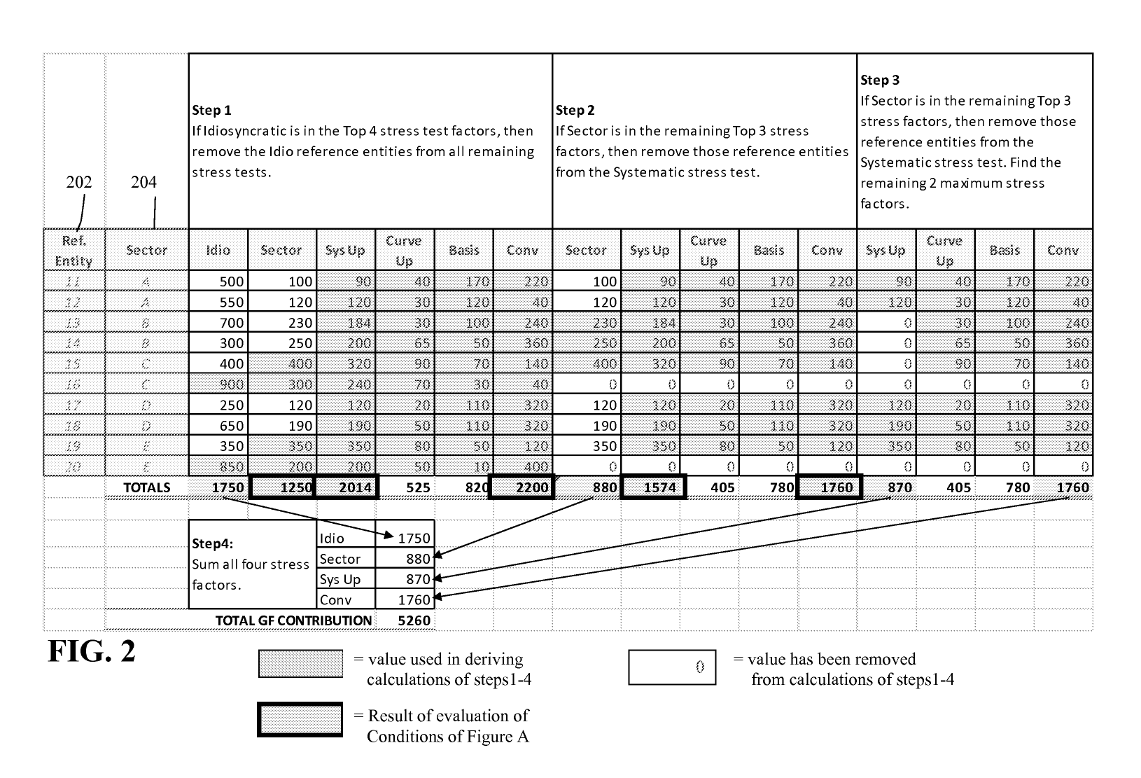

In particular, according to FIG. 1, all six stress test factors are computed and rank ordered, as described above (block 102, also denoted as Step 1). If neither the result of the Idiosyncratic stress test or the result of the Sector stress test are in the four maximum stress test results (blocks 104, 106), the GF Stress Test result is the summation of the four maximum stress test results (block 108). However, if the result of the Idiosyncratic stress test is one of the four maximum stress test results (block 104), regardless of whether or not the result of the Sector stress test is one of the four maximum stress test results, all of the remaining stress tests are recalculated without the two entities having the maximum two results of the idiosyncratic test, i.e. the two entities that were defaulted or brought back to health, and ranked in order as described above (block 110, also denoted as Step 2). If the result of the recalculated Sector stress test is one of the top three results (block 110), then Systematic stress test is recalculated after removing all relevant sectors, i.e. the two sectors that represent the highest and second highest loss, from the calculation and the recalculated and the recalculated result along with the previously recalculated stress test results are rank ordered (block 118, also denoted as Step 3). The GF Stress Test Result is then the summation of initially calculated result of the Idiosyncratic Stress Test, the previously recalculated result of the Sector stress test and two maximum results of the most recently recalculated stress tests (block 120). If the result of the recalculated Sector stress test is not one of the top three results (block 110), the GF stress test result is computed as the summation of the recalculated result of the Idiosyncratic stress test plus the three maximum results of the other recalculated stress tests (block 112). Alternatively, if the Idiosyncratic stress test result is not one of the top four maximum stress test results (block 104) but the result of the Sector stress test is one of the top four maximum stress test results (block 106), then the result of the Systematic stress test is recalculated after removing all relevant sectors, i.e. the two sectors that represent the highest and second highest loss, from the calculation and the recalculated results along with the previously calculated results of the other stress tests are rank ordered (block 114, also denoted as Step 4). The GF stress test result is then the summation of the recalculated result of the Sector stress test plus the three maximum results of the remaining stress tests. (block 116). Note that the references in FIG. 1 to “calc 1”, “calc 2”, “calc 3” and “calc 4” correspond to the exemplary calculations identified as steps 1-4 shown in FIG. 2.

An example of this process is shown in FIG. 2 which shows how micro risks are removed from macro risks (Idiosyncratic from all stress factors; Sector from Systematic). The denoted steps shown in FIG. 1 correspond to the Steps denoted in FIG. 2. The reference entity designations 202 shown in the table identify the CDS underlying entity for each position in the portfolio. The Sector designations 204 are based on the Bloomberg Sector Definitions which defines the following sectors: Basic Materials, Consumer Non-Cyclical, Consumer Cyclical, Financials, Health Care, Industrials, Oil & Gas, Sovereign, Technology, Telecommunications, and Utilities.

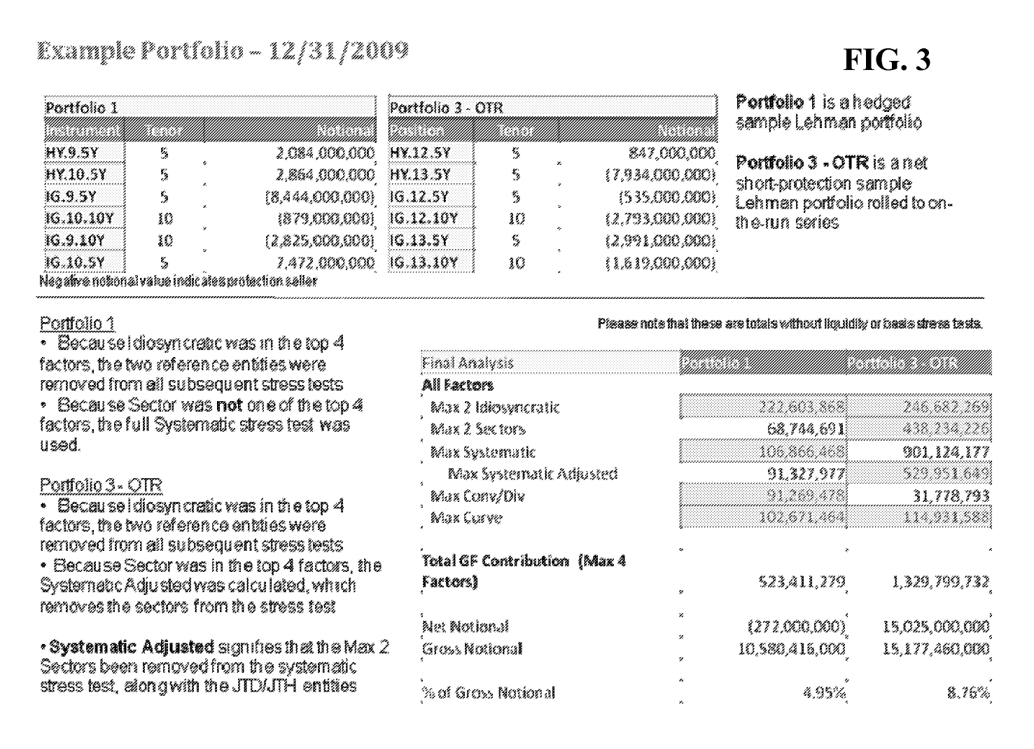

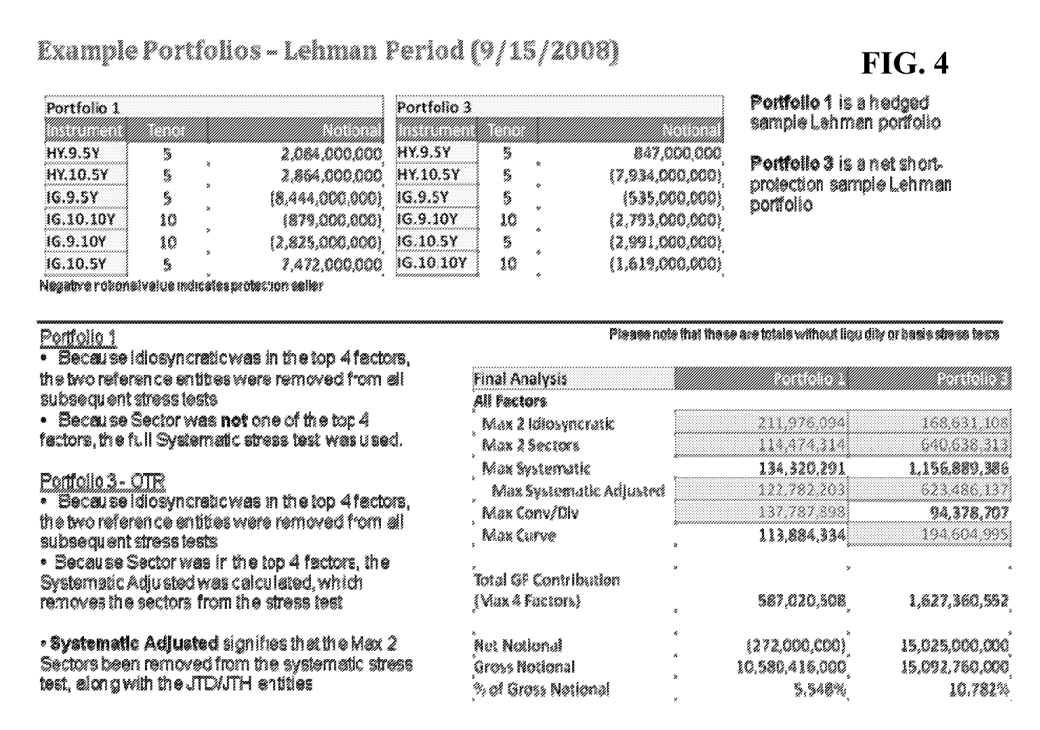

FIGS. 3 and 4 demonstrate the application of the disclosed GF contributions sizing process of FIGS. 1 and 2 to exemplary portfolios.

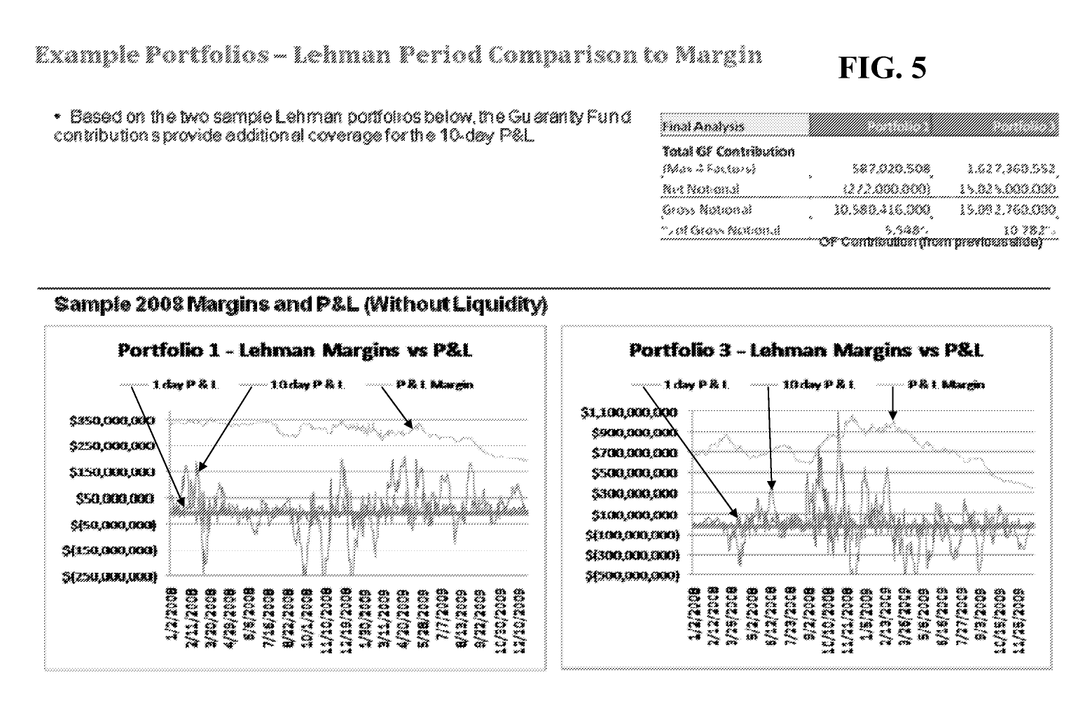

FIG. 5 shows a comparison of two different Lehman Brothers portfolios during a credit crisis period demonstrating that, for portfolio “1”, there isn't much tail risk as evident by time-series of 1-day and 10-day profit and loss (“P&L”). For this portfolio, margin is sufficient to cover these losses. However, for portfolio “3”, 10-day P&L exceeds the margin. In this case, the GF contribution is sufficient to cover the excess by which P&L exceeds margin. The difference between size of GF for both of these portfolios will be appreciated.

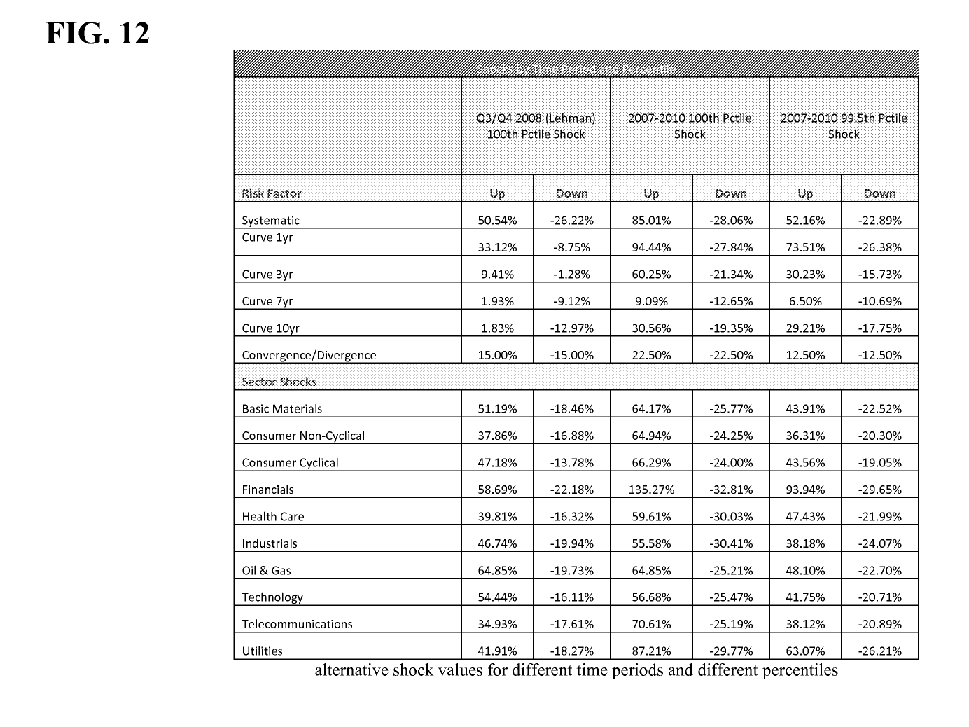

The following is a detailed description of each exemplary stress test factor. Current shock levels may be derived, for example, from 99.5th percentile data for the time period 2007 to 2009. Examples of other shock values are shown in FIG. 12.

For all of the stress tests, the change in the value of a position (i.e., the profit and loss or P&L) is defined as follows:

ΔV_{t,n}^{j}(s_{t,n}^{j}(1+δ))≡V_{t,n}^{j}(Qₙ^{j},s_{t,n}^{j}(1+δ))−V_{t,n}^{j}(Qₙ^{j},s_{t,n}^{j})

where δ is a shock added to or subtracted from the starting spread. The net notional amount Qₙ^{j} will indicate whether the exposure is long or short, thus ensuring that ΔV will have the appropriate sign. Nevertheless, because the net notional does not change in the scenario analyses, the argument may be dropped from the ΔV for notational simplicity.

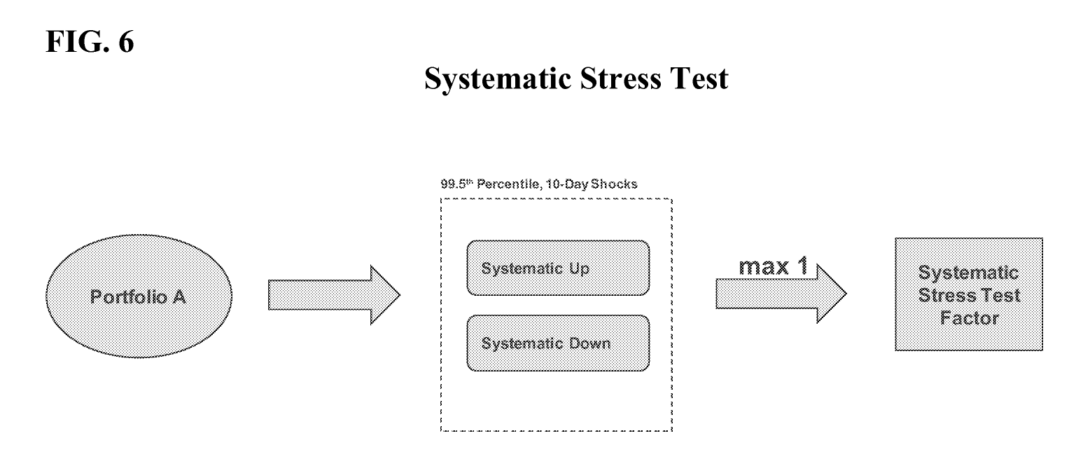

Systematic Stress Test: a block diagram of the Systematic Stress Test is shown in FIG. 6. The Systematic Stress Test tests. In particular:
The systematic shocks are derived from 10-day returns of on-the-run CDS Index Company (“CDX”) Investment Grade (“IG”) or High Yield (“HY”), tenor 5 spreads, i.e. contracts having 5 year spreads; the max of IG and HY is taken.
The clearing member portfolio undergoes systematic up and systematic down shocks; the maximum loss is the contribution to the overall stress test Portfolio A undergoes systematic up and systematic down shocks. The maximum loss is the Systematic Stress Test Factor.

In particular, for each day t in the parameter estimation period, define the absolute daily change in spread for the CDX.IG index for the 5-year tenor as follows:

Δs_{t,5}^{CDX.IG}=|s_{t,n}^{CDX.IG}−s_{t-1,n5}^{CDX.IG}|

Now denote the 99.5^{th} percentile observation of the empirical distribution of Δs_{t,5}^{CDX.IG} over all dates in the parameter estimation period as Δs₅^{0.995} for the 5-year CDX.IG. The shock parameter, δₛ, is then defined as follows:

δₛ=Δs₅^{0.995}

In other words, the systematic risk shock factor is the largest absolute 99.5^{th} percentile daily change in spread on the 5-year CDX.IG/HY over a given estimation period.

The current spreads associated with all other tenors (non 5-year) are shocked “up” and “down” in a manner consistent with the 5-year tenor shocks in order to maintain the slope of the curve (i.e., shocks across all tenors are applied in parallel). The shock factor then is applied to each CDS current spread in an “up” and “down” manner to arrive at an “up” and “down” scenario, respectively. The systematic risk Stress P&L for a portfolio is the greatest loss arising from either the “up” or “down” scenario as applied to all individual CDS holdings within the portfolio:

$${M}_{s}^{IG} = max \{ \vert {\sum }_{j = 1}^{J} {\sum }_{n ∈ N} Δ V ( {s}_{t , n}^{j} ( 1 + {δ}_{s} ) ) \vert , \vert {\sum }_{j = 1}^{J} {\sum }_{n ∈ N} Δ V ( {s}_{t , n}^{j} ( 1 - {δ}_{s} ) ) \vert \}$$

$${M}_{s}^{HY} = max \{ \vert {\sum }_{j = 1}^{J} {\sum }_{n ∈ N} Δ V ( {s}_{t , n}^{j} ( 1 + {δ}_{s} ) ) \vert , \vert {\sum }_{j = 1}^{J} {\sum }_{n ∈ N} Δ V ( {s}_{t , n}^{j} ( 1 - {δ}_{s} ) ) \vert \}$$

$${M}_{s} = max \{ {M}_{s}^{IG} , {M}_{s}^{HY} \}$$

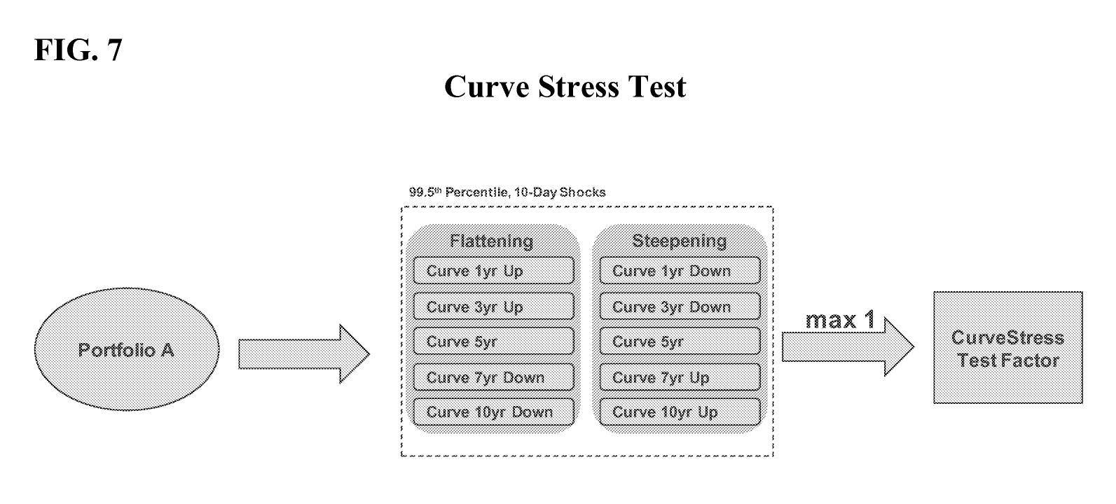

Curve Stress Test: a block diagram of the Curve Stress Test is shown in FIG. 7. The Curve Stress Test tests for non-parallel movements in the CDS curve(s) that would not be captured by systematic stress test. In particular:
The curve shocks are derived from difference in 10-day returns between tenor points of the CDX IG spreads
The clearing member portfolio undergoes flattening and steepening shocks with specific up/down shocks applied to each tenor point; the maximum is the contribution to the overall stress test, i.e. the maximum loss of Flattening or Steepening is the Curve Stress Test Factor

In particular, For each day t in the parameter estimation period, define the daily percentage change in spread for the j^{th} reference name and the n^{th} tenor as:

$$Δ {s}_{t , n}^{j} = \frac{{s}_{t , n}^{j} - {s}_{t - 1 , n}^{j}}{{s}_{t - 1 , n}^{j}}$$

Then define the average change in spreads across all reference entities within each tenor on each day t in the parameter estimation period as follows:

$$\overline{Δ {s}_{t , n}} = \frac{1}{{J}_{n}} {\sum }_{j = 1}^{{J}_{n}} Δ {s}_{t , n}^{j}$$

where Jₙ denotes the number of reference entities with tenor n.

For each day t in the estimation period, we now define ratios of average spread changes by tenor (for all tenors except the 5-year) relative to the average spread change of the 5-year tenor:

$${θ}_{t , n} = \frac{\overline{Δ {s}_{t , n}}}{\overline{Δ {s}_{t , 5}}} ∀ n ∈ N$$

Now denote the 0.5^{th} and 99.5^{th} percentile observation of these average spread ratios by tenor as θₙ^{0.005} and θₙ^{0.995}, respectively.

We now define tenor-specific “up” and “down” shocks as follows:

δ_{c}^{1,u}=θ₁^{0.995} δ_{c}^{3,u}=θ₃^{0.995} δ_{c}^{7,u}=θ₇^{0.995} δ_{c}^{10,u}=θ₁₀^{0.995}

δ_{c}^{1,d}=θ₁^{0.005} δ_{c}^{3,d}=θ₃^{0.005} δ_{c}^{7,d}=θ₇^{0.005} δ_{c}^{10,d}=θ₁₀^{0.005}

Based on those tenor-specific “up” and “down” shocks, the model then computes the change in value across all individual CDS holdings within a portfolio according to two scenarios: a curve-flattening scenario and a curve-steepening scenario. The two changes in portfolio value are computed as follows:

$$Δ {V}_{c}^{flattening} = {\sum }_{j = 1}^{J} \{ Δ V ( {s}_{t , 1}^{j} ( 1 + {δ}_{c}^{1 , u} ) ) + Δ V ( {s}_{t , 3}^{j} ( 1 + {δ}_{c}^{3 , u} ) ) + Δ V ( {s}_{t , 7}^{j} ( 1 - {δ}_{c}^{7 , d} ) ) + Δ V ( {s}_{t , 10}^{j} ( 1 - {δ}_{c}^{10 , d} ) ) \}$$

$$Δ {V}_{c}^{steepening} = {\sum }_{j = 1}^{J} \{ Δ V ( {s}_{t , 1}^{j} ( 1 - {δ}_{c}^{1 , d} ) ) + Δ V ( {s}_{t , 3}^{j} ( 1 - {δ}_{c}^{3 , d} ) ) + Δ V ( {s}_{t , 7}^{j} ( 1 + {δ}_{c}^{7 , u} ) ) + Δ V ( {s}_{t , 10}^{j} ( 1 + {δ}_{c}^{10 , u} ) ) \}$$

The curve risk factor P&L required for the portfolio is then:

M_{c}=max{|ΔV_{c}^{flattening}|,|ΔV_{c}^{steepening}|}

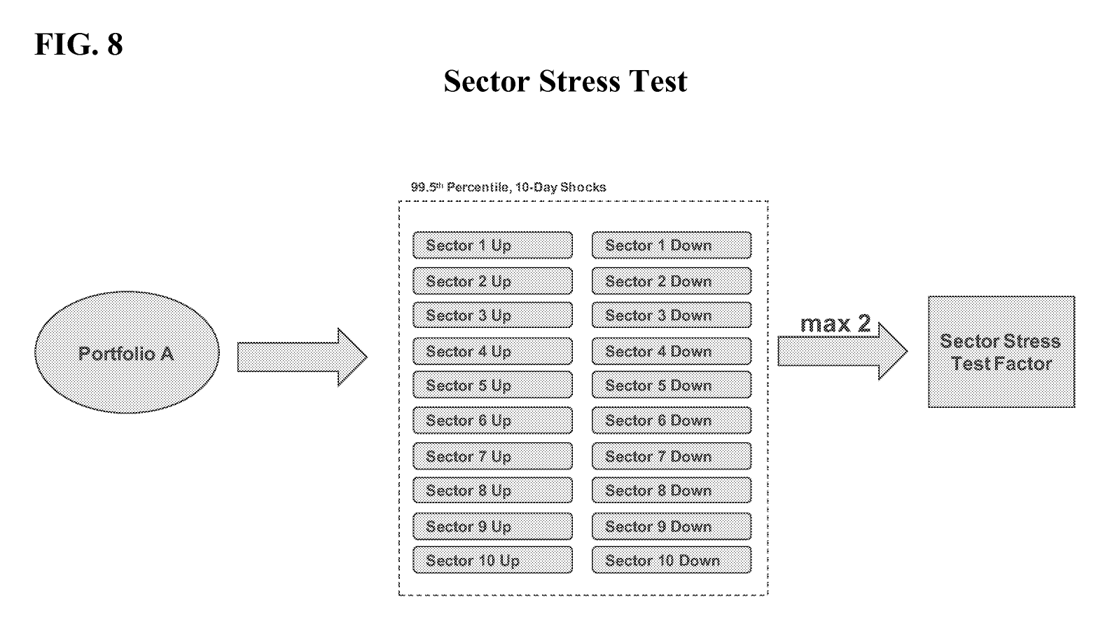

Sector Stress Test: a block diagram of the Sector Stress Test is shown in FIG. 8. The Sector Stress Test captures the risk that one of a few entities in a sector could make the entire sector risky. This stress test aims to model concentration risk. In particular:
The sector shocks are derived from 10-day returns of various single names grouped by sector
The sector shocks are relative to each sector (i.e. Financials has a financials-specific shock, etc.)
The sector shocks are floored at the systematic shock levels (e.g. if systematic up shock is 75%, and the Telecommunications up shock is 60%, then Telecommunications will use the 75% up shock)
The maximum 2 values from the 20 shocks (10 sectors, up/down) will be added to derive the Sector contribution to the overall stress test. Two sectors are chosen to address correlation of the financial sector to other sectors Portfolio A undergoes relative sector shocks (each shock percentage is specific to the sector). The shocks are floored by the systematic shock percentage. The losses are then summed by sector. The maximum TWO losses of the 20 sector stress tests is the Sector Stress Factor

In particular, of the J total single-name CDSs in the portfolio, suppose there are K total industries/sectors to which the J reference names belong. Let Zₖ denote an index set of the individual reference names included in sector k, and let Nₖ denote the total number of reference entities included in sector k (such that Σₖ₌₁^{K}Nₖ=J).

The sector risk factor is based on the 5-year tenor for each reference entity. For each day t in the parameter estimation period, define the daily change in the 5-year spread for the j^{th} reference name as:

$$Δ {s}_{t , 5}^{j} = \frac{{s}_{t , 5}^{j} - {s}_{t - 1 , 5}^{j}}{{s}_{t - 1 , 5}^{j}}$$

On each day t in the parameter estimation period, the average absolute change in 5-year spreads across all reference entities for each sector k is as follows:

$$\overline{Δ {s}_{t}^{k}} = \frac{1}{{N}_{k}} {\sum }_{{j = 1}_{j ∈ {Z}_{k}}}^{{N}_{k}} \vert Δ {s}_{t , n}^{j} \vert ∀ k$$

Define the 0.5^{st} and 99.5^{th} percentile average absolute change in spread for each sector as θₖ^{0.005} and θₖ^{0.995}, respectively. The maximum of these numbers defines the sector-specific risk factor. The maximum average absolute change in spread across all sectors comprises the overall sector risk shock factor:

δ_{z}=max{[θₖ^{0.005},θₖ^{0.995}],δₛ}

Where δₛ is the systematic shock computed above. This means all sector shocks are floored by systematic shock to reflect the fact that sector shocks should capture the specific extreme stress tests in excess of general market shocks.

All CDS's are then repriced by applying the shock factor δ_{z} to the individual CDS current spreads as both an up-shock and a down-shock, with values netted across tenor and reference name. The maximum absolute change in value in the k^{th} sector across the up- and down-shocks can be defined as:

$$Δ {V}_{z}^{k} = max \{ \vert {\sum }_{{n = 1}_{n ∈ N}}^{10} {\sum }_{{j = 1}_{j ∈ {Z}_{k}}}^{{N}_{k}} Δ V ( {s}_{t , n}^{j} ( 1 + {δ}_{z} ) ) \vert , \vert {\sum }_{{n = 1}_{n ∈ N}}^{10} {\sum }_{{j = 1}_{j ∈ {Z}_{k}}}^{{N}_{k}} Δ V ( {s}_{t , n}^{j} ( 1 - {δ}_{z} ) ) \vert \}$$

The sector factor P&L for the portfolio is then:

$${M}_{z} = {{max}_{k ∈ K}}_{2} \{ Δ {V}_{z}^{k} \}$$

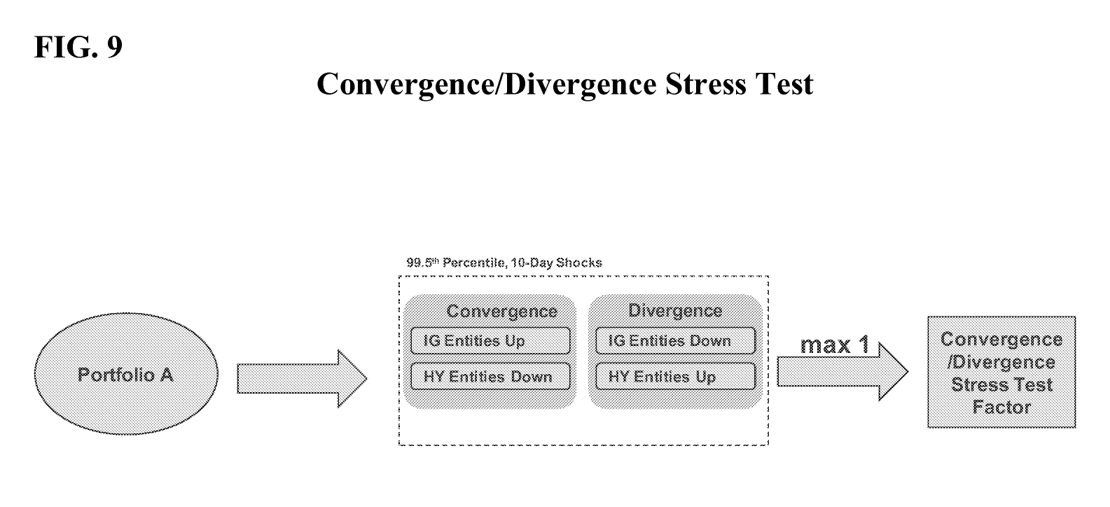

Convergence/Divergence Stress Test: a block diagram of the Convergence/Divergence Stress Test is shown in FIG. 9. The Convergence/Divergence Stress Test captures the risk of IG spreads/HY spreads moving away from expected values. This factor aims to capture risk embedded in portfolios that contain IG and HY positions, i.e. long HY short IG, vice-versa. In particular:
The curve shocks are derived from an analysis of 10-day returns of the 5-yr IG and 5-yr HY spreads
A threshold level of 400 bps is used to distinguish between HY and IG (<400 bps is IG)
The clearing member portfolio undergoes convergence and divergence shocks; the maximum is the contribution to the overall stress test Portfolio A undergoes Convergence and Divergence shocks. Each single name is classified as HY or IG (greater than or less than 4000 basis point 5-yr spread). For Convergence, IG is shocked up and HY is shocked down. For Divergence, IG is shocked down and HY is shocked up. The maximum loss of Convergence or Divergence is the Convergence/Divergence Stress Test Factor.

In particular, for each day t in the parameter estimation period, the daily change in spread for the j^{th} reference name and the n^{th} tenor is defined as:

$$Δ {s}_{t , n}^{j} = \frac{{s}_{t , n}^{j} - {s}_{t - 1 , n}^{j}}{{s}_{t - 1 , n}^{j}}$$

For all reference names j, a single-name CDS is classified as “investment-grade” if the current 5-year spread is less than 400 basis points and as “high-yield” otherwise. All tenors for any given reference name receive the same classification based on the 5-year spread for that reference name. As such, we define two index sets of reference entities as follows:

J^{IG}={j:s_{t,5}^{j}<400}

J^{HY}={j:s_{t,5}^{j}≧400}

Let J_{ig} and J_{hy} denote the number of elements in each reference set, respectively.

Then, for each day t, define the average change in spreads across all reference entities within each tenor by credit spread classification:

$$\overline{Δ {s}_{t , n}^{IG}} = \frac{1}{{J}_{ig}} {\sum }_{{j = 1}_{j ∈ {J}^{IG}}}^{{J}_{ig}} Δ {s}_{t , n}^{j}$$

$$\overline{Δ {s}_{t , n}^{HY}} = \frac{1}{{J}_{hy}} {\sum }_{{j = 1}_{j ∈ {J}^{HY}}}^{{J}_{hy}} Δ {s}_{t , n}^{j}$$

Now define the following sets for all tenors n:

Cₙ={ Δ̅s̅_̅{̅t̅,̅n̅}̅^̅{̅I̅G̅}̅, Δ̅s̅_̅{̅t̅,̅n̅}̅^̅{̅H̅Y̅}̅: Δ̅s̅_̅{̅t̅,̅n̅}̅^̅{̅I̅G̅}̅< Δ̅s̅_̅{̅t̅,̅n̅}̅^̅{̅H̅Y̅}̅}

Dₙ={ Δ̅s̅_̅{̅t̅,̅n̅}̅^̅{̅I̅G̅}̅, Δ̅s̅_̅{̅t̅,̅n̅}̅^̅{̅H̅Y̅}̅: Δ̅s̅_̅{̅t̅,̅n̅}̅^̅{̅I̅G̅}̅> Δ̅s̅_̅{̅t̅,̅n̅}̅^̅{̅H̅Y̅}̅}

For any tenor n, the sets Cₙ and Dₙ reflect convergence (i.e., change in investment-grade spread exceeds change in high-yield spread) and divergence (i.e., change in high-yield spread exceeds change in investment-grade spread). Further define:

Xₙ={ Δ̅s̅_̅{̅t̅,̅n̅}̅^̅{̅I̅G̅}̅, Δ̅s̅_̅{̅t̅,̅n̅}̅^̅{̅H̅Y̅}̅: Δ̅s̅_̅{̅t̅,̅n̅}̅^̅{̅I̅G̅}̅= Δ̅s̅_̅{̅t̅,̅n̅}̅^̅{̅H̅Y̅}̅}

For each tenor, the CME computes the maximum convergence or divergence. Geometrically, each tenor-specific set of pairs is graphed on a scatter plot along with a 45° line. The spread pair at the furthest distance from the 45° line for any given tenor represents the greatest incident of convergence or divergence over the estimation period in that tenor:

Cₙ*=supₜ{\sqrt{(Δs_{t,n}^{IG}−Δs_{0,n}^{IG})²+(Δs_{t,n}^{HY}−Δs_{0,n}^{HY})²}:Δs_{t,n}^{IG},Δs_{t,n}^{HY}εCₙ,Δs_{0,n}^{IG},Δs_{0,n}^{HY}εXₙ}

Dₙ*=infₜ{\sqrt{(Δs_{t,n}^{IG}−Δs_{0,n}^{IG})²+(Δs_{t,n}^{HY}−Δs_{0,n}^{HY})²}:Δs_{t,n}^{IG},Δs_{t,n}^{HY}εDₙ,Δs_{0,n}^{IG},Δs_{0,n}^{HY}εXₙ}

The shock factor is then defined as the maximum convergence or divergence observed across all tenors:

δₓ=max_{nεN}{Cₙ*,Dₙ*}

The shock factor is applied to each CDS in the portfolio in an appropriate upward or downward manner by credit spread classification to revalue the portfolio for both convergence and divergence scenarios. Note that the same shock is applied to all tenors in a proportional manner to ensure that the curve retains its original shape—i.e., shocks across all tenors are parallel.

The curve is shocked up and down separately for HY versus IG names within each scenario.

$$Convergence \text{:} Δ {V}_{x}^{IG , u} + Δ {V}_{x}^{HY , d} = {\sum }_{j = 1}^{J} Δ {V}_{x}^{IG} ( {s}_{t , n}^{IG , j} ( 1 + {δ}_{x} ) ) + Δ {V}_{x}^{HY} ( {s}_{t , n}^{HY , j} ( 1 - {δ}_{x} ) )$$

$$D ivergence \text{:} Δ {V}_{x}^{IG , d} + Δ {V}_{x}^{HY , u} = {\sum }_{j = 1}^{J} Δ {V}_{x}^{IG} ( {s}_{t , n}^{IG , j} ( 1 - {δ}_{x} ) ) + Δ {V}_{x}^{HY} ( {s}_{t , n}^{HY , j} ( 1 + {δ}_{x} ) )$$

The factor P&L is equal to the maximum loss for the entire portfolio resulting from either the convergence or divergence scenario.

Mₓ=max{|ΔVₓ^{convergence}|,|ΔVₓ^{divergence}|}

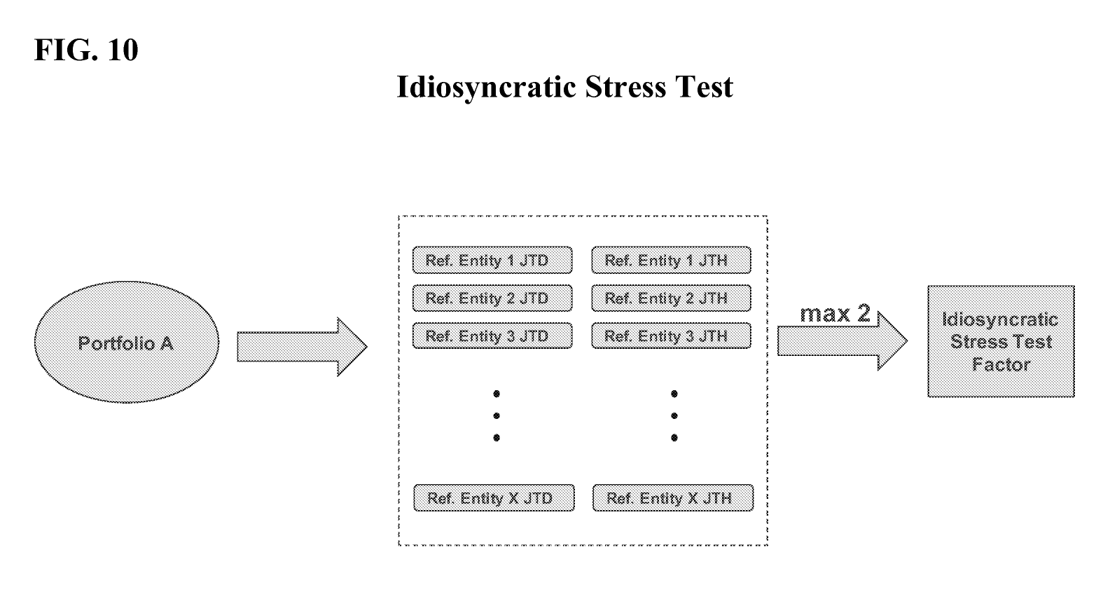

Idiosyncratic Stress Test: a block diagram of the Idiosyncratic Stress Test is shown in FIG. 10. The Idiosyncratic Stress Test captures the risk of entities jumping to default or being brought back to health instantaneously. This represents firm specific risk. In particular:
Positions of different tenors, but the same reference entity are summed
The Idiosyncratic stress test defaults each reference entity with zero recovery; and alternatively jumps to par
The maximum two reference entity jump-to-default (JTD) or jump-to-health (JTH) will be summed to derive the Idiosyncratic contribution to the overall stress test
The exposure of each reference entity in Portfolio A is netted across tenors. Each reference entity undergoes Jump to Default (“JTD”) with a recovery of zero, and Jump to Health (“JTH”) to par. The maximum TWO losses are the idiosyncratic stress test factor.

In particular, the idiosyncratic risk consists of JTD and JTH risk factors. For any given CDS reference entity j, the JTD/JTH risk factor is defined as:

JTDⱼ=Vₜ^{j}(1−δⱼ^{JTD}),JTHⱼⁿ=Vₜ^{j}(1−δⱼ^{JTH})

Where Vₜ^{j} is the total value of a reference entity aggregated across tenor; δᵢ^{JTD} represents the assumed recovery rate, in the case of guaranty fund computation, this recovery rate is assumed to be zero. Given the same logic, δⱼ^{JTH} represents an extreme case where a defaulting entity bailout to its par value (δⱼ^{JTH}=10%).

Each reference entity in the portfolio is then stressed with JTD and JTH value, a max of this two is taken to represent the idiosyncratic risk of this particular entity:

Λⱼ=max{JTDⱼ,JTHⱼ}

The idiosyncratic Stress Factor P&L is then computed by taking the largest two across all entities:

$${M}_{I} = {max}_{j = 2} \{ {Λ}_{j} \}$$

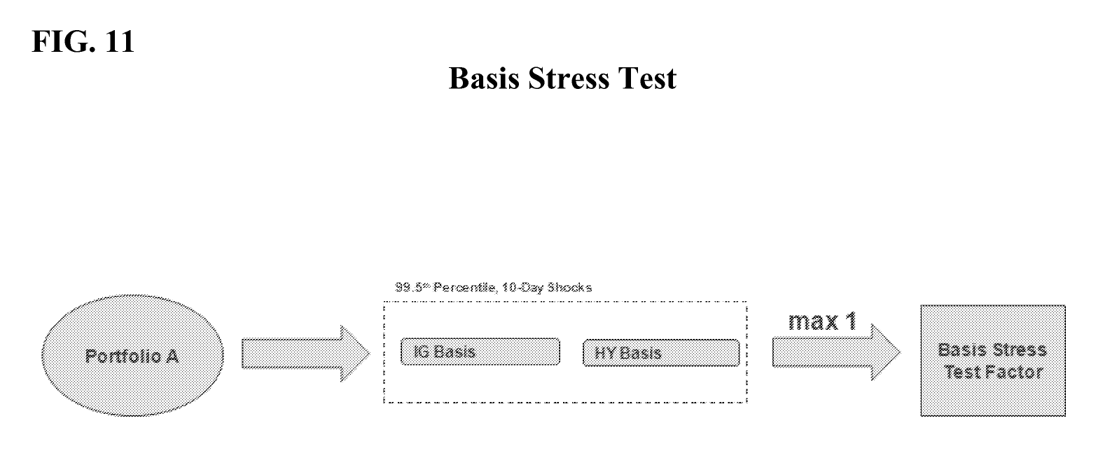

Basis Stress Test: a block diagram of the Basis Stress Test is shown in FIG. 11. The Basis Stress Test captures the risk of mispricing an index relative to its constituents. This factor aims to capture risks in total and partial arbitrage portfolios, i.e. long the index and short all or some constituents. In particular:
Basis Factor is only applicable for portfolios that include IG or HY positions
The Basis shocks are derived from an analysis of 10-day returns of the basis—i.e. difference—between 5-yr IG/HY and its components
Basis Factor could be applied either to gross notional or net notional

In particular, the final factor in the proposed CME guaranty fund model is intended to capture the basis risk of index positions vis-à-vis the underlying single-name CDS positions in the index. Thus, it is only applicable to the index positions within a portfolio. Denote the number of indices cleared by the CME as W. Let denote an index set of the individual reference names included in index w, and let N_{w} denote the total number of reference entities included in index w.

For each day t in the parameter estimation period, define the basis on a 5-year tenor between each index and its constituents as follows:

$${b}_{t , 5}^{w} = \underbrace{V ( {s}_{t , 5}^{w} )}_{{Value of}_{{Quoted}_{Index}}} - \underbrace{{\sum }_{{j = 1}_{j ∈ {Z}_{w}}}^{{N}_{w}} V ( {s}_{t , 5}^{j} )}_{{Value of Index}_{Components}}$$

A ratio δ_{w} is then computed based on 10 days of the most recent basis.

$${δ}_{w} = {\sum }_{t = 1}^{10} \vert {b}_{t , 5}^{w} \vert \times ( 1 + 50 \% {I}_{w} )$$

In the above shock factor definition, I_{w} is an indicator variable that assumes a value of 0 if index w has only one to three series trading at the time and a value of 1 is index w has four or more series clearing. In other words, the shock value for any index with four or more series clearing is increased by 50%.

The total basis risk factor P&L for a portfolio that includes any index positions is then defined as follows:

$${M}_{b} = {\sum }_{w = 1}^{w} {Q}_{w} {δ}_{w}$$

where Q_{w} is the gross or net notional amount of each index w held in the portfolio. (For indices with no representation in the portfolio, Q_{w}=0.)

As was described above with respect to FIG. 1, after the six stress test factors are calculated they are rank ordered. Under certain conditions, to avoid double-counting correlated risks, the micro risks must be removed from the macro risks. For example, if idiosyncratic (JTD/JTH) is included in the max four factors, the reference entities involved in JTD/JTH are removed from all other factors, then the factors are re-calculated.

In one embodiment, the worst case liquidity stress test is computed as a function of the volume, bid/ask spread, inactivity & staleness of quotes for each reference entity. In particular, a ratio is taken to represent each variable for liquidity test. The definitions are as follows:

$${v}_{t , i} = \frac{{V}_{t , i}}{{V}_{t , Syr}^{CDX . IG}} , {bos}_{t , i} = \frac{{BOS}_{t , i}}{{BOS}_{t , Syr}^{CDX . IG}} , {IoN}_{t , i} = \frac{{IoN}_{t , i}}{{IoN}_{t , Syr}^{CDX . IG}}$$

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superceding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

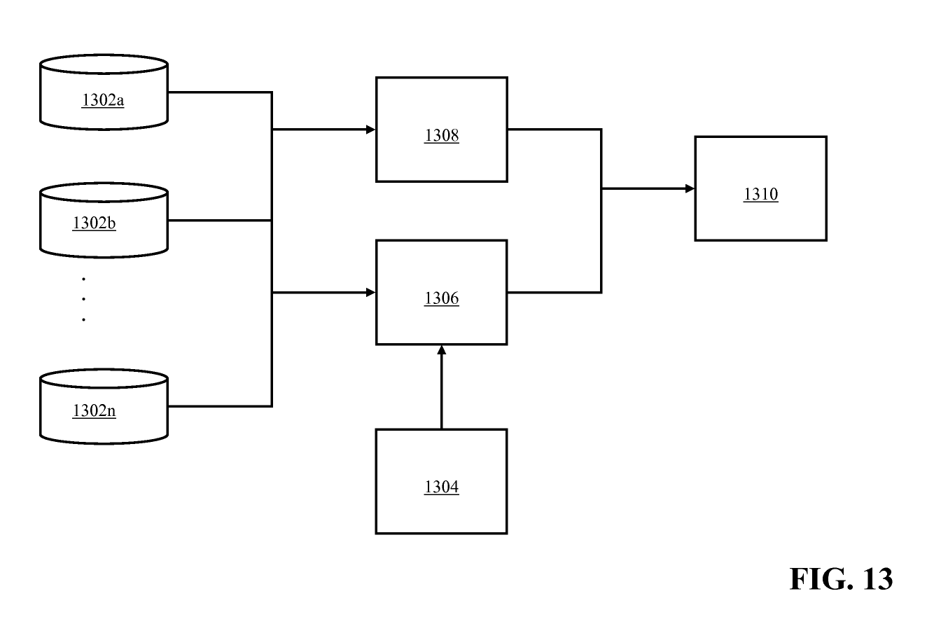

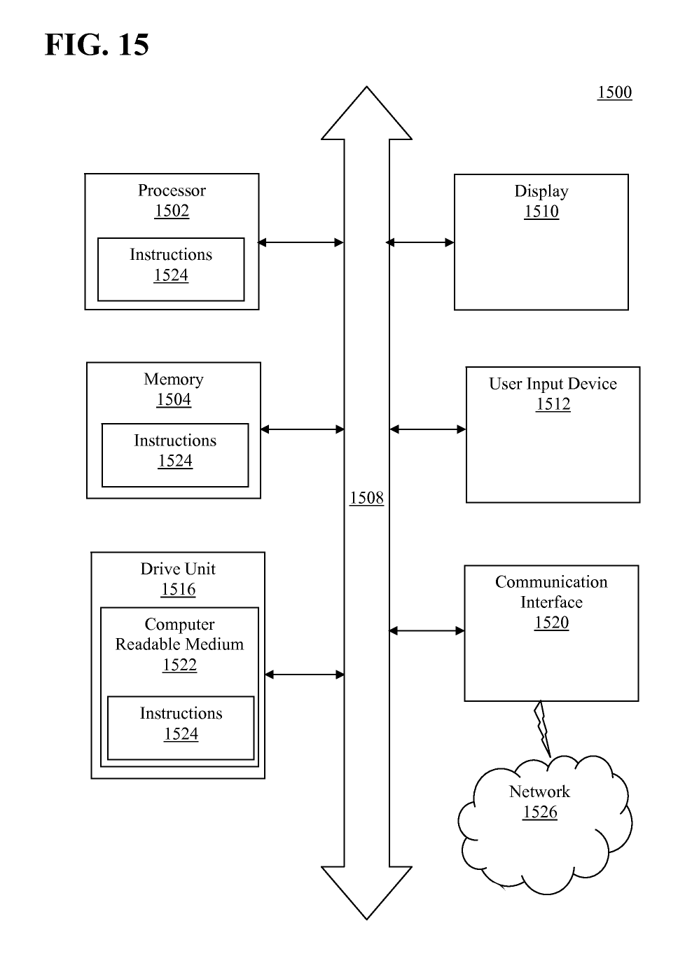

Referring to FIG. 13 there is shown a block diagram of an exemplary system 1300 for determining an amount of a fund to cover mutual systemic risk of loss among a plurality of entities trading credit default swap (“CDS”) instruments using a central counterparty, such as the CME, where each of the plurality of entities maintains a portfolio 1302a-n comprising at least one position in a CDS instrument based on an underlying reference entity, the portfolio 1302a-n being characterized by a value. The system 1300 may be implemented in a computer such as the computer 1500 described in more detail below with respect to FIG. 15. The system 1300 includes a scenario identifier 1304 operative to, for each of a plurality of portfolios, identify a scenario for each of a plurality of conditions, each scenario comprising a change to the associated condition which may result in a loss of value, such as the maximum loss of value, to any of the at least one position of the portfolio 1302a-n. In one embodiment, each scenario corresponds to a stress test, such as one of the six stress tests identified above. The system may further include a loss processor 1306 coupled with the scenario identifier 1304 and operative to, for each scenario, determine an aggregate loss value of the changes in value of each of the at least one position based on an occurrence of the associated condition change. Herein, the phrase “coupled with” is defined to mean directly connected to or indirectly connected through one or more intermediate components. Such intermediate components may include both hardware and software based components.

The loss processor 1306 may be further operative to identify a subset of the aggregate loss values comprising the largest aggregate loss value and for each of the subset and corresponding scenario, recalculate, for each of the other scenarios, the aggregate loss value of the changes in value of each of the at least one position based on an occurrence of the associated condition change, wherein at least a subset of those positions whose change in value is correlated with a change in value determined as a result of the occurrence of a change of the condition associated with the corresponding scenario and not already excluded from an aggregate thereof, are excluded from the recalculated aggregate loss value. The system further includes a liquidation cost processor 1308 operative to determine an aggregate liquidation cost of the costs to liquidate all of the at least one position of the portfolio 1302a-n, such as by calculating the worst case liquidity factor identified above, and a fund size processor 1310 coupled with the loss processor 1306 and the liquidation costs processor 1308 and operative to calculate, for each portfolio 1302a-n, a maximum loss value as a summation of at least a subset the determined and recalculated aggregate loss values and determined aggregate liquidation cost, discount each maximum loss value by an amount assessed to the respective one of the plurality of entities by the central counter party to cover short term loss of value in the respective portfolio, e.g. the margin requirement, and determine the amount of the fund based on a summation of at least a subset, e.g. the two largest, of the discounted maximum loss values. In one embodiment, the fund size processor 1310 is further operative to apportion contribution to the fund among the plurality of entities.

In on embodiment, a first scenario of the identified scenarios may include a change of financial status of a reference entity underlying a CDS instrument from one of in default or not in default to the other of not in default or in default. Further, the two of the at least one position having the largest change in value based on the occurrence of the associated condition change of the first scenario may be excluded from the recalculation of the aggregate loss values of the other identified scenarios. Alternatively, or in addition thereto, a second scenario of the identified scenarios may include an adverse change to a reference entity underlying a CDS instrument affecting other reference entities underlying other CDS instruments in the same industrial sector. Further, wherein yet a third scenario of the identified scenarios comprises an occurrence of an event which impacts an entire market for CDS instruments, the two of the at least one position having the largest change in value based on the occurrence of the associated condition change of the second scenario being excluded from the recalculation of the aggregate loss value of the third scenario. Alternatively, or in addition thereto, a scenario of the identified scenarios may include an occurrence of an event which impacts an entire market for CDS instruments. Alternatively, or in addition thereto, a scenario of the identified scenarios may include an event which effects a subset of CDS instruments based on maturity thereof. Alternatively, or in addition thereto, a scenario of the identified scenarios comprises an adverse change in CDS instruments characterized as one of low risk or high risk. Alternatively, or in addition thereto, a scenario of the identified scenarios may include a mispricing of an index of constituent CDS instruments relative to the constituent CDS instruments.

In one embodiment, a first change in value of a one of the at least one position based on a first condition change associated with a first scenario is correlated with a second change in value of another of the at least one position based on a second condition change associated with a second scenario when the first change and second change are of an equivalent magnitude. Alternatively, or in addition thereto, a first change in value of a one of the at least one position based on a first condition change associated with a first scenario is correlated with a second change in value of another of the at least one position based on a second condition change associated with a second scenario when the first condition is related to the second condition. In particular, the first condition change may be a cause of the second condition change. Further, the second scenario may not result in a loss in excess of the loss resulting from the first scenario.

In one embodiment, the system 1300 is implemented in a computer, such as the computer 1500 described below with respect to FIG. 15, having a processor 1502 and a memory 1504 coupled therewith, for determining an amount of a fund to cover mutual systemic risk of loss among a plurality of entities trading credit default swap (“CDS”) instruments using a central counterparty, each of the plurality of entities maintaining a portfolio comprising at least one position in a CDS instrument based on an underlying reference entity, the portfolio being characterized by a value. The system may further include: first logic stored in the memory and executable by the processor to, for each of the plurality of portfolios 1302a-n, identify a scenario for each of a plurality of conditions, each scenario comprising a change to the associated condition which may result in a loss of value to any of the at least one position of the portfolio 1302a-n; second logic stored in the memory and executable by the processor to, for each scenario, determine an aggregate loss value of the changes in value of each of the at least one position based on an occurrence of the associated condition change; third logic stored in the memory and executable by the processor to identify a subset of the aggregate loss values comprising the largest aggregate loss value and for each of the subset and corresponding scenario, recalculate, for each of the other scenarios, the aggregate loss value of the changes in value of each of the at least one position based on an occurrence of the associated condition change, wherein at least a subset of those positions whose change in value is correlated with a change in value determined as a result of the occurrence of a change of the condition associated with the corresponding scenario and not already excluded from an aggregate thereof, are excluded from the recalculated aggregate loss value; fourth logic stored in the memory and executable by the processor to determine an aggregate liquidation cost of the costs to liquidate all of the at least one position of the portfolio; and fifth logic stored in the memory and executable by the processor to calculate, for each portfolio, a maximum loss value as a summation of at least a subset the determined and recalculated aggregate loss values and determined aggregate liquidation cost, discount each maximum loss value by an amount assessed to the respective one of the plurality of entities by the central counter party to cover short term loss of value in the respective portfolio, and determine the amount of the fund based on a summation of at least a subset of the discounted maximum loss values.

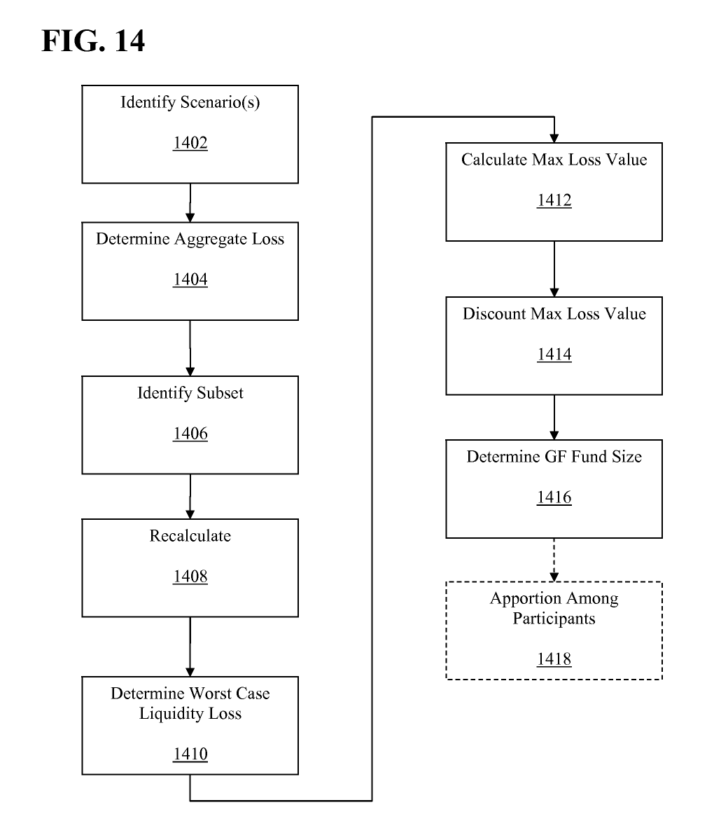

Referring to FIG. 14, there is shown a flow chart depicting operation of the system 1300 described above for determining an amount of a fund to cover mutual systemic risk of loss among a plurality of entities trading credit default swap (“CDS”) instruments using a central counterparty, each of the plurality of entities maintaining a portfolio 1302a-n comprising at least one position in a CDS instrument based on an underlying reference entity, the portfolio 1302a-n being characterized by a value.

In particular, the operation may include: identifying, by a processor, for each of the plurality of portfolios 1302a-n, a scenario for each of a plurality of conditions, each scenario comprising a change to the associated condition which may result in a loss of value, such as the maximum loss of value, to any of the at least one position of the portfolio 1302a-n (block 1402); for each scenario, determining, by the processor, an aggregate loss value of the changes in value of each of the at least one position based on an occurrence of the associated condition change (block 1404); identifying, by the processor, a subset of the aggregate loss values comprising the largest aggregate loss value and for each of the subset and corresponding scenario (block 1406), recalculating, for each of the other scenarios, the aggregate loss value of the changes in value of each of the at least one position based on an occurrence of the associated condition change, wherein at least a subset of those positions whose change in value is correlated with a change in value determined as a result of the occurrence of a change of the condition associated with the corresponding scenario and not already excluded from an aggregate thereof, are excluded from the recalculated aggregate loss value (block 1408); determining, by the processor, an aggregate liquidation cost of the costs to liquidate all of the at least one position of the portfolio 1302a-n (block 1410); calculating for each portfolio 1302a-n, by the processor, a maximum loss value as a summation of at least a subset the determined and recalculated aggregate loss values and determined aggregate liquidation cost (block 1412); discounting, by the processor, each maximum loss value by an amount assessed to the respective one of the plurality of entities by the central counter party to cover short term loss of value in the respective portfolio (block 1414), e.g. a margin requirement; and determining, by the processor, the amount of the fund based on a summation of at least a subset of the discounted maximum loss values (block 14116). The operation may further include apportioning contributions to the fund among each of the plurality of entities (block 1418).

In one embodiment, a first scenario of the identified scenarios may include a change of financial status of a reference entity underlying a CDS instrument from one of in default or not in default to the other of not in default or in default. Further, the two of the at least one position having the largest change in value based on the occurrence of the associated condition change of the first scenario may be excluded from the recalculation of the aggregate loss values of the other identified scenarios. Alternatively, or in addition thereto, a second scenario of the identified scenarios may include an adverse change to a reference entity underlying a CDS instrument affecting other reference entities underlying other CDS instruments in the same industrial sector. Further, wherein yet a third scenario of the identified scenarios comprises an occurrence of an event which impacts an entire market for CDS instruments, the two of the at least one position having the largest change in value based on the occurrence of the associated condition change of the second scenario being excluded from the recalculation of the aggregate loss value of the third scenario. Alternatively, or in addition thereto, a scenario of the identified scenarios may include an occurrence of an event which impacts an entire market for CDS instruments. Alternatively, or in addition thereto, a scenario of the identified scenarios may include an event which effects a subset of CDS instruments based on maturity thereof. Alternatively, or in addition thereto, a scenario of the identified scenarios comprises an adverse change in CDS instruments characterized as one of low risk or high risk. Alternatively, or in addition thereto, a scenario of the identified scenarios may include a mispricing of an index of constituent CDS instruments relative to the constituent CDS instruments.

In one embodiment, a first change in value of a one of the at least one position based on a first condition change associated with a first scenario is correlated with a second change in value of another of the at least one position based on a second condition change associated with a second scenario when the first change and second change are of an equivalent magnitude. Alternatively, or in addition thereto, a first change in value of a one of the at least one position based on a first condition change associated with a first scenario is correlated with a second change in value of another of the at least one position based on a second condition change associated with a second scenario when the first condition is related to the second condition. In particular, the first condition change may be a cause of the second condition change. Further, the second scenario may not result in a loss in excess of the loss resulting from the first scenario.

Referring to FIG. 15, an illustrative embodiment of a general computer system 1500 is shown. The computer system 1500 can include a set of instructions that can be executed to cause the computer system 1500 to perform any one or more of the methods or computer based functions disclosed herein. The computer system 1500 may operate as a standalone device or may be connected, e.g., using a network, to other computer systems or peripheral devices. Any of the components discussed above, such as the scenario identifier 1304, the loss processor 1306, the liquidation cost processor 1308 and/or the fund size processor 1310, may be a computer system 1500 or a component in the computer system 1500. The computer system 1500 may implement a match engine, margin processing, payment or clearing function on behalf of an exchange, such as the Chicago Mercantile Exchange, of which the disclosed embodiments are a component thereof.

In a networked deployment, the computer system 1500 may operate in the capacity of a server or as a client user computer in a client-server user network environment, or as a peer computer system in a peer-to-peer (or distributed) network environment. The computer system 1500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1500 can be implemented using electronic devices that provide voice, video or data communication. Further, while a single computer system 1500 is illustrated, the term “system” shall also be taken to include any collection of systems or sub-systems that individually or jointly execute a set, or multiple sets, of instructions to perform one or more computer functions.

As illustrated in FIG. 15, the computer system 1500 may include a processor 1502, e.g., a central processing unit (CPU), a graphics processing unit (GPU), or both. The processor 1502 may be a component in a variety of systems. For example, the processor 1502 may be part of a standard personal computer or a workstation. The processor 1502 may be one or more general processors, digital signal processors, application specific integrated circuits, field programmable gate arrays, servers, networks, digital circuits, analog circuits, combinations thereof, or other now known or later developed devices for analyzing and processing data. The processor 1502 may implement a software program, such as code generated manually (i.e., programmed).

The computer system 1500 may include a memory 1504 that can communicate via a bus 1508. The memory 1504 may be a main memory, a static memory, or a dynamic memory. The memory 1504 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 1504 includes a cache or random access memory for the processor 1502. In alternative embodiments, the memory 1504 is separate from the processor 1502, such as a cache memory of a processor, the system memory, or other memory. The memory 1504 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1504 is operable to store instructions executable by the processor 1502. The functions, acts or tasks illustrated in the figures or described herein may be performed by the programmed processor 1502 executing the instructions stored in the memory 1504. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1500 may further include a display unit 1514, such as a liquid crystal display (LCD), an organic light emitting diode (OLED), a flat panel display, a solid state display, a cathode ray tube (CRT), a projector, a printer or other now known or later developed display device for outputting determined information. The display 1514 may act as an interface for the user to see the functioning of the processor 1502, or specifically as an interface with the software stored in the memory 1504 or in the drive unit 1506.

Additionally, the computer system 1500 may include an input device 1516 configured to allow a user to interact with any of the components of system 1500. The input device 1516 may be a number pad, a keyboard, or a cursor control device, such as a mouse, or a joystick, touch screen display, remote control or any other device operative to interact with the system 1500.

In a particular embodiment, as depicted in FIG. 15, the computer system 1500 may also include a disk or optical drive unit 1506. The disk drive unit 1506 may include a computer-readable medium 1510 in which one or more sets of instructions 1512, e.g. software, can be embedded. Further, the instructions 1512 may embody one or more of the methods or logic as described herein. In a particular embodiment, the instructions 1512 may reside completely, or at least partially, within the memory 1504 and/or within the processor 1502 during execution by the computer system 1500. The memory 1504 and the processor 1502 also may include computer-readable media as discussed above.

The present disclosure contemplates a computer-readable medium that includes instructions 1512 or receives and executes instructions 1512 responsive to a propagated signal, so that a device connected to a network 1520 can communicate voice, video, audio, images or any other data over the network 1520. Further, the instructions 1512 may be transmitted or received over the network 1520 via a communication port 1518. The communication port 1518 may be a part of the processor 1502 or may be a separate component. The communication port 1518 may be created in software or may be a physical connection in hardware. The communication port 1518 is configured to connect with a network 1520, external media, the display 1514, or any other components in system 1500, or combinations thereof. The connection with the network 1520 may be a physical connection, such as a wired Ethernet connection or may be established wirelessly as discussed below. Likewise, the additional connections with other components of the system 1500 may be physical connections or may be established wirelessly.

The network 1520 may include wired networks, wireless networks, or combinations thereof. The wireless network may be a cellular telephone network, an 802.11, 802.16, 802.20, or WiMax network. Further, the network 1520 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter. It is therefore intended that the foregoing detailed description be regarded as illustrative rather than limiting, and that it be understood that it is the following claims, including all equivalents, that are intended to define the spirit and scope of this invention.

1. A computer implemented method of determining an amount of a fund to cover mutual systemic risk of loss among a plurality of entities trading credit default swap (“CDS”) instruments using a central counterparty, each of the plurality of entities maintaining a portfolio comprising at least one position in a CDS instrument based on an underlying reference entity, the portfolio being characterized by a value, the method comprising:
identifying, by a processor, for each of the plurality of portfolios, a scenario for each of a plurality of conditions, each scenario comprising a change to the associated condition which may result in a loss of value to any of the at least one position of the portfolio;
for each scenario, determining, by the processor, an aggregate scenario loss value of the changes in value of each of the at least one position based on an occurrence of the change to the associated condition change;
identifying, by the processor, a subset of the aggregate scenario loss values comprising the largest combined aggregate loss value for a selected number of scenarios comprising the subset, and for each scenario of the subset;
recalculating, for each of the other scenarios in the subset, a recalculated aggregate loss value of changes in value of each of the at least one position based on an occurrence of the change to the associated condition, wherein at least one of those positions whose change in value is correlated with a change in value determined as a result of the occurrence of the change of the condition associated with the corresponding scenario and not already excluded from an aggregate thereof, are excluded from the recalculated aggregate loss value;
determining, by the processor, an aggregate liquidation cost of the costs to liquidate all of the at least one position of the portfolio;
calculating for each portfolio, by the processor, a maximum loss value as a summation of at least a subset of the determined and recalculated aggregate loss values and determined aggregate liquidation cost;
discounting, by the processor, each maximum loss value by an amount assessed to the respective one of the plurality of entities by the central counter party to cover short term loss of value in the respective portfolio; and
determining, by the processor, the amount of the fund based on a summation of at least a subset of the discounted maximum loss values.

2. The computer implemented method of claim 1 wherein a first scenario of the identified scenarios comprises a change of financial status of a reference entity underlying a CDS instrument from one of in default or not in default to the other of not in default or in default.

3. The method of claim 2 wherein the two of the at least one position having the largest change in value based on the occurrence of the associated condition change of the first scenario are excluded from the recalculation of the aggregate loss values of the other identified scenarios.

4. The computer implemented method of claim 1 wherein a first scenario of the identified scenarios comprises an adverse change to a reference entity underlying a CDS instrument affecting other reference entities underlying other CDS instruments in the same industrial sector.

5. The computer implemented method of claim 4 wherein a second scenario of the identified scenarios comprises an occurrence of an event which impacts an entire market for CDS instruments, the two of the at least one position having the largest change in value based on the occurrence of the associated condition change of the first scenario being excluded from the recalculation of the aggregate loss value of the second scenario.

6. The computer implemented method of claim 1 wherein a first scenario of the identified scenarios comprises an occurrence of an event which impacts an entire market for CDS instruments.

7. The computer implemented method of claim 1 wherein a first scenario of the identified scenarios comprises an event which effects a subset of CDS instruments based on maturity thereof.

8. The computer implemented method of claim 1 wherein a first scenario of the identified scenarios comprises an adverse change in CDS instruments characterized as one of low risk or high risk.

9. The computer implemented method of claim 1 wherein a first scenario of the identified scenarios comprises a mispricing of an index of constituent CDS instruments relative to the constituent CDS instruments.

10. The computer implemented method of claim 1 wherein a first change in value of one of the at least one position based on a first condition change associated with a first scenario is correlated with a second change in value of another of the at least one position based on a second condition change associated with a second scenario when the first change and second change are of an equivalent magnitude.

11. The computer implemented method of claim 1 wherein a first change in value of one of the at least one position based on a first condition change associated with a first scenario is correlated with a second change in value of another of the at least one position based on a second condition change associated with a second scenario when the first condition is related to the second condition.

12. The computer implemented method of claim 11 wherein the first condition change is a cause of the second condition change.

13. The computer implemented method of claim 11 wherein the second scenario does not result in a loss in excess of the loss resulting from the first scenario.

14. The computer implemented method of claim 1 wherein the subset of the determined and recalculated aggregate loss values comprises a four largest of the aggregate loss values.

15. The computer implemented method of claim 1 further comprising apportioning contributions to the fund among each of the plurality of entities.

16. The computer implemented method of claim 1 wherein the change to the associated condition of each scenario results in a maximum loss of the value.

17. The computer implemented method of claim 1 wherein the amount assessed to the respective one of the plurality of entities by the central counter party to cover short term loss of value in the respective portfolio comprises a margin requirement.

18. The computer implemented method of claim 1 wherein subset of the discounted maximum loss values comprises the two largest of the discounted maximum loss values.

19. A computer implemented system for determining an amount of a fund to cover mutual systemic risk of loss among a plurality of entities trading credit default swap (“CDS”) instruments using a central counterparty, each of the plurality of entities maintaining a portfolio comprising at least one position in a CDS instrument based on an underlying reference entity, the portfolio being characterized by a value, the system comprising:
a scenario identifier operative to, for each of the plurality of portfolios, identify a scenario for each of a plurality of conditions, each scenario comprising a change to the associated condition which may result in a loss of value to any of the at least one position of the portfolio;
a loss processor coupled with the scenario identifier and operative to, for each scenario, determine an aggregate loss value of the changes in value of each of the at least one position based on an occurrence of the change to the associated condition;
the loss processor being further operative to identify a subset of the aggregate scenario loss values comprising the largest combined aggregate loss value for a selected number of scenarios comprising the subset, and for each scenario of the subset;
recalculating, for each of the other scenarios in the subset, a recalculated aggregate loss value of changes in value of each of the at least one position based on an occurrence of the change to the associated condition, wherein at least one of those positions whose change in value is correlated with a change in value determined as a result of the occurrence of the change of the condition associated with the corresponding scenario and not already excluded from an aggregate thereof, are excluded from the recalculated aggregate loss value;
a liquidation cost processor operative to determine an aggregate liquidation cost of the costs to liquidate all of the at least one position of the portfolio; and
a fund size processor coupled with the loss processor and the liquidation costs processor and operative to calculate, for each portfolio, a maximum loss value as a summation of at least a subset of the determined and recalculated aggregate loss values and determined aggregate liquidation cost, discount each maximum loss value by an amount assessed to the respective one of the plurality of entities by the central counter party to cover short term loss of value in the respective portfolio, and determine the amount of the fund based on a summation of at least a subset of the discounted maximum loss values.

20. The system of claim 19 wherein a first scenario of the identified scenarios comprises a change of financial status of a reference entity underlying a CDS instrument from one of in default or not in default to the other of not in default or in default.

21. The system of claim 20 wherein the two of the at least one position having the largest change in value based on the occurrence of the associated condition change of the first scenario are excluded from the recalculation of the aggregate loss values of the other identified scenarios.

22. The system of claim 19 wherein a first scenario of the identified scenarios comprises an adverse change to a reference entity underlying a CDS instrument affecting other reference entities underlying other CDS instruments in the same industrial sector.

23. The system of claim 22 wherein a second scenario of the identified scenarios comprises an occurrence of an event which impacts an entire market for CDS instruments, the two of the at least one position having the largest change in value based on the occurrence of the associated condition change of the first scenario being excluded from the recalculation of the aggregate loss value of the second scenario.

24. The system of claim 19 wherein a first scenario of the identified scenarios comprises an occurrence of an event which impacts an entire market for CDS instruments.

25. The system of claim 19 wherein a first scenario of the identified scenarios comprises an event which effects a subset of CDS instruments based on maturity thereof.

26. The system of claim 19 wherein a first scenario of the identified scenarios comprises an adverse change in CDS instruments characterized as one of low risk or high risk.

27. The system of claim 19 wherein a first scenario of the identified scenarios comprises a mispricing of an index of constituent CDS instruments relative to the constituent CDS instruments.

28. The system of claim 19 wherein a first change in value of a one of the at least one position based on a first condition change associated with a first scenario is correlated with a second change in value of another of the at least one position based on a second condition change associated with a second scenario when the first change and second change are of an equivalent magnitude.

29. The system of claim 19 wherein a first change in value of a portfolio based on a first condition change associated with a first scenario is correlated with a second change in value of the portfolio based on a second condition change associated with a second scenario when the first condition is related to the second condition.

30. The system of claim 29 wherein the first condition change is a cause of the second condition change.

31. The system of claim 29 wherein the second scenario does not result in a loss in excess of the loss resulting from the first scenario.

32. The system of claim 19 wherein the subset of the determined and recalculated aggregate loss values comprises a four largest of the aggregate loss values.

33. The system of claim 19 wherein the fund size processor is further operative to apportion contributions to the fund among each of the plurality of entities.

34. The system of claim 19 wherein the change to the associated condition of each scenario results in a maximum loss of the value.

35. The system of claim 19 wherein the amount assessed to the respective one of the plurality of entities by the central counter party to cover short term loss of value in the respective portfolio comprises a margin requirement.

36. The system of claim 19 wherein subset of the discounted maximum loss values comprises the two largest of the discounted maximum loss values.

37. A system for determining an amount of a fund to cover mutual systemic risk of loss among a plurality of entities trading credit default swap (“CDS”) instruments using a central counterparty, each of the plurality of entities maintaining a portfolio comprising at least one position in a CDS instrument based on an underlying reference entity, the portfolio being characterized by a value, the method comprising:
means for identifying, by a processor, for each of the plurality of portfolios, a scenario for each of a plurality of conditions, each scenario comprising a change to the associated condition which may result in a loss of value to any of the at least one position of the portfolio;
for each scenario, means for determining, by the processor, an aggregate loss value of the changes in value of each of the at least one position based on an occurrence of the change to the associated condition;
means for identifying, by the processor, a subset of the aggregate scenario loss values comprising the largest combined aggregate loss value for a selected number of scenarios comprising the subset, and for each scenario of the subset;
means for calculating, for each of the other scenarios in the subset, a recalculated aggregate loss value of changes in value of each of the at least one position based on an occurrence of the change to the associated condition, wherein at least one of those positions whose change in value is correlated with a change in value determined as a result of the occurrence of the change of the condition associated with the corresponding scenario and not already excluded from an aggregate thereof, are excluded from the recalculated aggregate loss value;
means for determining, by the processor, an aggregate liquidation cost of the costs to liquidate all of the at least one position of the portfolio;
means for calculating, for each portfolio, by the processor, a maximum loss value as a summation of at least a subset of the determined and recalculated aggregate loss values and determined aggregate liquidation cost;
means for discounting, by the processor, each maximum loss value by an amount assessed to the respective one of the plurality of entities by the central counter party to cover short term loss of value in the respective portfolio; and
means for determining, by the processor, the amount of the fund based on a summation of at least a subset of the discounted maximum loss values.

38. A system for determining an amount of a fund to cover mutual systemic risk of loss among a plurality of entities trading credit default swap (“CDS”) instruments using a central counterparty, each of the plurality of entities maintaining a portfolio comprising at least one position in a CDS instrument based on an underlying reference entity, the portfolio being characterized by a value, the system comprising a processor and a memory coupled thereto, the system further comprising:
first logic stored in the memory and executable by the processor to, for each of the plurality of portfolios, identify a scenario for each of a plurality of conditions, each scenario comprising a change to the associated condition which may result in a loss of value to any of the at least one position of the portfolio;
second logic stored in the memory and executable by the processor to, for each scenario, determine an aggregate loss value of the changes in value of each of the at least one position based on an occurrence of the change to the associated condition;
third logic stored in the memory and executable by the processor to identify a subset of the aggregate scenario loss values comprising the largest combined aggregate loss value for a selected number of scenarios comprising the subset, and for each scenario of the subset, and recalculating, for each of the other scenarios in the subset, a recalculated aggregate loss value of changes in value of each of the at least one position based on an occurrence of the change to the associated condition, wherein at least one of those positions whose change in value is correlated with a change in value determined as a result of the occurrence of the change of the condition associated with the corresponding scenario and not already excluded from an aggregate thereof, are excluded from the recalculated aggregate loss value;
fourth logic stored in the memory and executable by the processor to determine an aggregate liquidation cost of the costs to liquidate all of the at least one position of the portfolio; and
fifth logic stored in the memory and executable by the processor to calculate, for each portfolio, a maximum loss value as a summation of at least a subset of the determined and recalculated aggregate loss values and determined aggregate liquidation cost, discount each maximum loss value by an amount assessed to the respective one of the plurality of entities by the central counter party to cover short term loss of value in the respective portfolio, and determine the amount of the fund based on a summation of at least a subset of the discounted maximum loss values.
